(19) United States
(12) Patent Application Publication
(10) Pub. No.: US 2013/0340634 A1
(43) Pub. Date: Dec. 26, 2013

(54) PRESSURE VESSEL SEALING

(71) Applicants: Mats Gardin, Vasteras (SE); Stefan Sehlstedt, Vasteras (SE)

(72) Inventors: Mats Gardin, Vasteras (SE); Stefan Sehlstedt, Vasteras (SE)

(73) Assignee: Avure Technologies AB, Vasteras (SE)

(21) Appl. No.: 13/978,617

(22) PCT Filed: Jan. 7, 2011
(86) PCT No.: PCT/EP2011/050169

§ 371 Date: Sep. 16, 2013

(51) Int. Cl. B30B 15/02

(52) U.S. Cl. CPC B30B 15/02
USPC 100/240; 220/669

(57) ABSTRACT

A pressure vessel comprising a pressure chamber (5) arranged for accommodating a pressure medium, comprising at least one cylinder segment (2) arranged for longitudinal connection to form a cylinder body (1), whereby a joint (7) is formed at adjacent edges (6) of the at least one cylinder segment for sealing the adjacent edges, and first pre-stressing means (20) arranged for exerting radial compressive forces on the at least one cylinder segment for attaining tangential compressive stress (16) at the joint(s).

### FIELD OF THE INVENTION

The present invention relates to the field of high pressure pressing, and in particular, a pressure vessel for isostatic pressing.

### BACKGROUND OF THE INVENTION

High-pressure presses are often used for the densification of powdered or cast materials, such as e.g. turbine blades for aircrafts, to achieve elimination of material porosity. Hence, pressure is applied to an article placed in the press in order to substantially increase the service life and the strength of the article, in particular the fatigue strength. Another field of application is the manufacture of products which are required to be fully dense and to have pore-free surfaces.

An article to be subjected to treatment by high-pressure pressing is positioned in a load compartment of a pressure chamber. After loading, the chamber is sealed off and a pressure medium, either a liquid or a gas, is introduced into the pressure chamber and the load compartment thereof. The press usually comprises a furnace provided with electric heating elements for increasing the temperature in the pressure chamber. The pressure and temperature of the pressure medium is increased, subjecting the article to a high pressure and temperature during a selected period of time. When the pressing of the articles is finished, the articles often need to be cooled before being removed, or unloaded, from the pressure chamber.

The pressures, temperatures, and treatment times are dependent on factors such as e.g. the material properties of the article to be treated, the field of application and/or the required quality of the article. Depending on the temperature of the pressure medium during an isostatic pressing process, the process can be called a hot isostatic pressing (hereinafter referred to as HIP), wherein the pressures typically may reach up to 300 MPa, warm isostatic pressing (herein referred to as a WIP), or cold isostatic pressing (hereinafter referred to as CIP), wherein the pressures can reach up to 700 MPa.

A cylinder for a high-pressure press is traditionally manufactured by forging, wherein a body is first cast and subsequently forged. More specifically, a rough cylindrical body is first cast, which is then forged to expand into a hollow cylinder body of suitable diameter and wall thickness. The forging process provides the advantage of increasing the strength of the cast material. In order to withstand high internal pressures, the cylinder body is then pre-stressed by means which radially compress the cylinder, the cylinder wall thereby being subjected to tangential compressive stresses. Pre-stressing further minimizes the risk of crack formation/propagation in the cylinder wall and, hence, reduces the risk of pressure vessel failure.

For the manufacture of very large cylinders, high demands are put on the equipments for the forging-, heat treatment- and machining processes. Recently, an increased demand for larger and larger sizes of the articles to be pressed has evolved, implying a demand for an increase of the volumes of the pressure chambers, often beyond what is possible with the pressure vessels of today. In addition, the conventional production method described above is complex and time consuming. This, in combination with a limited number of qualified suppliers, may cause problems regarding long times of delivery. Hence, there is a need of improved pressure vessels and, particularly, pressure vessels that are capable of coping with the continuously increasing requirements and demands of the business and customers.

### SUMMARY OF THE INVENTION

It is an object of the present invention to provide improved devices and methods which alleviate at least some of the above mentioned problems.

This and other objects are achieved by providing a pressure vessel and a high-pressure press for having the features defined in the independent claim. Preferred embodiments are defined in the dependent claims.

According to a first aspect of the present invention, there is provided a pressure vessel comprising a pressure chamber arranged for accommodating a pressure medium. The pressure vessel further comprises at least one cylinder segment arranged for longitudinal connection to form a cylinder body, whereby a joint is formed at adjacent edges of the at least one cylinder segment for sealing the adjacent edges. Furthermore, first pre-stressing means are arranged for exerting radial compressive forces on the at least one cylinder segment for attaining tangential compressive stress at the joint(s).

According to a second aspect of the present invention, there is provided a high-pressure press for isostatic pressure treatment of articles, comprising a pressure vessel according to the first aspect of the present invention, including a force-absorbing press frame provided around the force absorbing pressure body.

The pressure vessel of the present invention is based on the insight of providing an improved pressure vessel by the joint(s) which is/are formed at adjacent longitudinal edges of the cylinder segments for sealing the adjacent edges. The joint provides a fluid-tight seal at the adjacent edges such that pressure medium does not leak between the adjacent edges during operation of the pressure vessel. The joint further decreases the risk of crack formation and/or breakage between adjacent edges of the cylinder segments, thereby improving the strength of the cylinder body.

The constructional features of the pressure vessel, e.g. the structure of the cylinder segments, pre-stressing means, etc, may be provided in accordance with the description in the co-pending application “Residual stress reduction in welding”. Further advantages and design and construction details are described thoroughly in the said co-pending application by the same applicant, which hereby is incorporated herein by reference.

During operation of the pressure vessel, the first pre-stressing means are arranged for exerting radial compressive forces on the cylinder segments. As the joints between cylinder segments may constitute critical points for the cylinder body due to these forces, especially at extreme pressures of the pressure vessel, there is a wish to provide a strong joint for an improved sealing and/or to avoid cracks or the like in the cylinder body, which may lead to a cylinder body leakage. However, the adjacent edges of the cylinder segments, which segments are to be connected to form the cylinder body, may comprise surface roughnesses, scratches, or the like, which may have occurred during the formation of the cylinder segments. After assembly of the cylinder segments into the cylinder body, uneven edges of the cylinder segments may lead to an increased risk of a breakage at adjacent edges of the cylinder body. The present invention is advantageous in that a joint is formed at adjacent edges of the cylinder segments for the purpose of sealing, wherein the joint comprises even, adjacent edges of the cylinder segments such that the edges evenly abut each other.

Moreover, the present invention may even further reduce the risk of leakage of the pressure medium if a recess/cavity is provided along at least a portion of each joint between adjacent longitudinal edges of the cylinder segments. As a recess/cavity may be provided for a relief of stress from the pressure vessel in the case of a crack formation of the cylinder body, the features of the present invention and a recess/cavity may further improve the safety aspects of the cylinder body of the pressure vessel. A recess/cavity as described may be provided in accordance with the description in the co-pending application “Residual stress reduction in welding”. Further advantages and design and construction details of the recess/cavity are described thoroughly in the said co-pending application by the same applicant, which hereby is incorporated herein by reference.

By assembling cylinder segments into a cylinder body, the present invention provides the further advantage of a manufacture of cylindrical pressure vessels of larger dimensions than manufactured today. A cylinder body comprising two or more cylinder segments, which are connected to form the cylinder body, is not limited by obstacles related to the manufacturing process of one single, large cylinder.

Furthermore, the present invention is advantageous regarding transports of the pressure vessels to the assembly site, i.e. that the pressure vessel can be transported in segments from the forger or the like, to the manufacturing and assembly site. For example, the present invention may contribute to the transportation and assembly of “Giga-HIPS”, which may be taller than 12 m and weigh over 600 tons. The present invention contributes to the arrangement of cylinder segments into cylinder bodies of e.g. HIP presses, wherein the cylinder segments are more easily transported compared to one-piece cylinders. Hence, one-piece constructions of very large pressure cylinders may be avoided.

A further advantage with the pressure vessel of the present invention is that the manufacture and transport of the cylinder body becomes cheaper. This manufacture of a cylindrical body in segments, wherein the segments may be identical, is more economically beneficial than the production of a cylinder body, which may be extremely large, in one piece. Furthermore, as the segments of the cylinder body are less bulky compared to a one-piece cylinder body, the transport of the cylinder body segments may be provided easier and faster, which also may have the consequence of a cheaper transport.

The present invention is further advantageous in that the joint may be sufficient for sealing purposes of the cylinder body when the stress from the pre-stressing means is applied to the cylinder body. Hence, the joint may render any interconnection superfluous between the adjacent cylinder segments, such as e.g. a weld. In other words, a weld may not be necessary for purposes of connection and/or sealing of the cylinder segments. As welding at the joint(s) of the cylinder segments may be circumstantial and/or time consuming, the joint of the present invention may provide a more conveniently assembled cylinder body. Furthermore, the present invention mitigates problems related to metallurgical changes in a weld which may arise during operation of the pressure vessel, especially under operations of high pressure and high temperature. As a consequence, the present invention may provide a more reliable interconnection at the joints, as a weld exerted to extreme conditions in terms of pressure and/or temperature may, possibly, be more susceptible for cracks. Moreover, a weld may often need heat treatment for stress relieving of the weld, thereby making the weld stronger. However, as such a heat treatment may be circumstantial and/or hazardous, the present invention further provides an advantage related to a cylinder body which may be assembled without the need of welds.

The present invention is also advantageous in relation to the operation of cooling articles to be treated provided in the pressure chamber. The cooling, also denoted “rapid cooling” or “ultra rapid cooling”, in relation to the gradient dT/dt, i.e. the fastness of the temperature decrease as a function of time, requires that the components and/or materials of the pressure vessel may sustain a fast temperature drop without being susceptible to failure. The present invention may withstand such a rapid temperature change without failure, and may thereby improve an operation of the pressure vessel comprising such a step, compared to other cylinder body arrangements.

According to an embodiment of the present invention, the pressure vessel may further comprise second pre-stressing means for exerting axial compressive forces on the at least one cylinder segment for attaining axial compressive stress at the joint(s). The benefits of an axial compressive stress from the second pre-stressing means are related to the benefits of a radial compressive stress from the first pre-stressing means at the joint. As these benefits have already been presented, they are omitted for the second pre-stressing means.

According to an embodiment of the present invention, the pressure vessel may further comprise at least one cylinder segment arranged for axial connection to form a cylinder body, whereby a joint is formed at adjacent edges of the at least one cylinder segment for sealing the adjacent edges. Hence, the cylinder body may further comprise at least one sub-cylinder, provided on top (or under) the pressure vessel comprising at least one cylinder segment arranged for longitudinal connection. In other words, as joints are formed longitudinally for the cylinder segments arranged for longitudinal connection, joints are analogously formed circumferentially for the cylinder segments arranged for axial connection. Analogously, the mentioned features and advantages for the pressure vessel comprising longitudinal segments, are also provided for the pressure vessel comprising cylinder segments arranged for axial connection. Hence, the further description of such features/advantages are omitted.

The joint may further seal the cylinder body at crossing adjacent edges. For example, in the case that cylinder segments are arranged for both longitudinal and axial connection, adjacent edges may cross longitudinally and axially.

According to an embodiment of the present invention, the joint may comprise at least one intermediate layer provided along at least a portion of each joint. By the term “intermediate layer”, it is in this context meant either a layer which is applied (i.e. fixed) to on one or both of the adjacent edges at the joint, or a layer which is removably placed or arranged between at the joint between the adjacent edges.

An advantage of the present embodiment is that the intermediate layer compensates for roughnesses/unevenesses of the adjacent edges of the cylinder segments at the joint. In other words, the intermediate layer may even or smoothen rough/uneven edges of the cylinder segments such that the adjacent edges may abut even more evenly when mounting the cylinder body. Hence, the intermediate layer may even further improve the sealing properties of the cylinder body during operation of the pressure vessel. In other words, the intermediate material even further mitigates the possibility of a leakage of the pressure medium at the joint(s), from the pressure chamber to the outside of the cylinder body.

A consequence of the arrangement of an intermediate layer is an even more improved pressure vessel in terms of safety. More specifically, the present embodiment even further reduces the risk of failure of the pressure vessel e.g. related to leakage, and thereby provides an ameliorated reliability in the operation of the pressure vessel. For example, the present invention may improve the safety of pressure vessels of extremely powerful HIP presses.

The intermediate layer may be provided along at least a portion of each joint, i.e. an intermediate layer may be provided between portions of adjacent edges of the cylinder segments with rough/uneven surfaces, whereas at portions of adjacent edges with even surfaces, the intermediate layer may be omitted. This provides the advantage of concentrating the provision of an intermediate layer to portions of adjacent edges where it is preferred to smoothen/even out the joint at the edges due to material roughnesses, whereas the intermediate layer may be omitted at portions of the adjacent edges where the edges may interconnect more evenly.

It is preferred that the intermediate layer preserves its sealing properties as a function of time, i.e. that the intermediate layer provides a sealing for the adjacent edges of the cylinder body even though long time may pass between pressure vessel operations. Furthermore, it is preferred that the intermediate layer preserves its sealing properties within the temperature and pressure variations of the pressure vessel.

According to an embodiment of the present invention, the intermediate layer may be a coating, a covering, a plating, or the like. In other words, the intermediate layer may be applied (i.e. fixed) to one or both of the adjacent edges of the cylinder segments at the joint. An advantage with the present embodiment is that the coating/covering/plating may imply a heating of the intermediate material which thereby may even further penetrate into small holes, cracks, or the like, of the cylinder segments, for smoothening the joint at the edges of cylinder segments. Furthermore, when the pre-stressing means apply stress at the joints of the cylinder body, an even tighter sealing may be attained. Another advantage with the present embodiment is that edges of cylinder segments which reveal roughnesses/unevenesses may be treated in advance, before the cylinder segments are assembled into the cylinder body. This gives a more preferred overview of portions of the edges of the cylinder segments which need to be treated, and reduces the need of treatment of the edges of the cylinder segments after assembly of the cylinder segments into the cylinder body. Furthermore, a coated/covered/plated layer which is fixed/applied to the cylinder segment edges provides an easier mounting of the cylinder segments into a cylinder body. For example, the intermediate layer applied to the edges of the cylinder segments reduces the risk of falling out of place when assembling the cylinder segments into the cylinder body.

The number of techniques related to coating, covering and plating are vast, and furthermore, such techniques are known to the man skilled in the art. Hence, any detailed description of how to apply the intermediate layer to one or more of the edges of the cylinder segments is therefore omitted.

According to an embodiment of the present invention, the intermediate layer may be a foil, a sheet, a plate, or the like. In other words, the intermediate layer may be a substantially thin layer or body provided/placed at the joint(s) at adjacent edges of the cylinder segments. An advantage with the embodiment of the present invention is that the intermediate layer may be inserted and/or removed from the joint(s) of the cylinder body, thereby facilitating the mounting and/or demounting of the cylinder body. For example, in case of failure of the pressure vessel, the cylinder body may be demounted and the intermediate layer may be removed and replaced, before pre-stressing the cylinder body again. The removal and/or replacement of the intermediate layer may be economically advantageous as the intermediate layer may be recycled and/or reused again at the joint(s) of the cylinder body.

According to an embodiment of the present invention, the intermediate layer may have a hardness which is below the hardness of the cylinder segments. In other words, the compression of the intermediate layer is higher than the compression of the cylinder segments, when exerted to the same pressure. Hence, during pre-stressing of the cylinder body, the adjacent edges of the cylinder segments at the joints will yield a pressure which is exerted on the intermediate material. The intermediate material, being softer than the cylinder segments, provides the advantage of an ability to deform at the adjacent edges of the joint, wherein the adjacent edges may comprise irregularities and/or scratches. In other words, a higher softness and/or ductility of the intermediate material compared to the material of the cylinder segments may even further even out any roughnesses/unevenesses at the joint(s), thereby even further improving the sealing of the adjacent edges of the cylinder segments.

The material property of the intermediate layer, being softer than the cylinder segments, provides the further advantage that the risk is reduced of any possible deformation of cylinder segments at the joints due to the intermediate layer at pre-stressing of the cylinder body. Hence, instead of the possibility of the intermediate material e.g. indenting the cylinder segment, the intermediate layer yields to the pressure exerted by the pre-stressing means on the joints.

According to an embodiment of the present invention, the at least one intermediate layer may have a bulk modulus below 250 GPa, preferably below 200 GPa. An advantage with this embodiment is that the layer may comprise a metal which is relatively soft, i.e. that a relatively soft metal used as an intermediate layer may yield to the pressure from the adjacent edges, and provide sealing properties at the joint at adjacent edges when stress is applied to the cylinder body.

According to an embodiment of the present invention, the intermediate layer may comprise at least one metal selected from Fe, Cu, Sn, Pb, Ag and Au. It will be appreciated that the intermediate layer may comprise one or more of the metals and/or any oxide, carbide, or the like, of the metals. Furthermore, it will be appreciated that impurities of any other material may also be present in the intermediate layer.

An advantage of an intermediate layer comprising Fe, Cu, Sn, Pb, Ag and/or Au is that the metals are relatively soft, i.e. that they are relatively compressible in comparison to other metals. Hence, one or more of the mentioned metals may smoothen out the surface at the joint at adjacent edges when stress is applied to the cylinder body. As a consequence, the sealing of the adjacent edges may be even further improved when using one or more of the metals as an intermediate layer.

An intermediate layer comprising Fe, Cu, Sn and/or Pb is particularly advantageous in that the mentioned metals are relatively cheap.

An intermediate layer comprising Ag is particularly advantageous in that silver is very ductile and has a relatively small work hardening coefficient. As a consequence, silver is capable of filling scratches and/or even out roughnesses at the joint of the adjacent edges of the cylinder segments during pre-stressing of the cylinder body, thereby providing a sealing. Although silver is relatively expensive, the cost for intermediate layers in silver in relation to the cost of the entire pressure vessel is small, or possibly even negligible.

Analogously, an intermediate layer comprising Au is particularly advantageous in that gold is extremely ductile and has a small work hardening coefficient. Hence, when pre-stressing the cylinder body, an intermediate layer of Au provides a smoothening of irregularities at the joint. Furthermore, the cost of an entire pressure vessel may hugely overshadow that of the cost of gold comprised in intermediate layers provided at the joint(s).

According to an embodiment of the present invention, the at least one intermediate layer may comprise at least one material selected from rubber, silicone, plastic and glue. An advantage with the embodiment of the present invention is that the mentioned materials, or compounds comprising one or more of the materials, are suitable sealants. Hence, an intermediate material comprising one or more of the materials mentioned may further prevent the penetration of pressure medium at a joint between edges of the cylinder segments during operation of the pressure vessel. In other words, an intermediate layer comprising rubber, silicon, plastic and/or glue may provide completely watertight seals.

Furthermore, if the intermediate material transforms from a viscous state to a solid state, the intermediate material may firstly be readily applied to the joint at the adjacent edges of the cylinder segments, and then solidify for sealing the adjacent edges. An advantage with an intermediate material of this kind is that a viscous intermediate material may be applied also to very small gaps at a joint, before solidifying.

Another advantage with the embodiment of the present invention is that the intermediate layer comprises a material which is very soft and ductile. Hence, these properties of the intermediate material may provide an even more enhanced smoothening of the joint at the adjacent edges of the cylinder segments, thereby tightening the sealing.

According to an embodiment of the present invention, the thickness of the intermediate layer may be comprised between 0.01-5 mm, preferably between 0.05-0.2 mm. An advantage of a thickness of the intermediate layer in the mentioned range is that the intermediate layer is sufficiently thick for the ability of the layer to smoothen unevenesses/roughnesses at the joint(s) of the cylinder segments, thereby providing an improved sealing of the cylinder body. At the same time, an advantage of a thickness of the intermediate layer in the mentioned range is that the intermediate layer is sufficiently thin for not leading to a possible gap at a possible junction from a portion of the joint provided with an intermediate layer to a portion of the joint wherein no intermediate layer is provided. Moreover, the intermediate layer may be sufficiently thin for economical reasons, if an expensive metal is used.

According to an embodiment of the present invention, the intermediate layer may be provided along at least a portion of the joint on an inner wall of the cylinder body. In other words, along the joints which may face the outside, the inside, the top and the bottom of the cylinder body, the intermediate layer extends along at least a portion of the joint which faces the inside of the cylinder body.

According to an embodiment of the present invention, the pressure vessel may further comprise at least one pre-stressed surfaces provided on at least one side of the joint for taking up forces exerted thereon from the pre-stressing means, and wherein the at least one pre-stressed surface is arranged for transferring the forces via the cylinder segments to the joint such that an additional compressive stress at the joint is attained. By this arrangement, the stress from the pre-stressing means may be magnified at the pre-stressed surfaces, compared to an arrangement without pre-stressed surfaces. As a consequence, the pre-stressed surfaces may even further contribute to the occurrence of compressive stresses at the joint wherein the intermediate material is provided. Hence, an advantage with the present embodiment is that the pre-stressed surfaces, which yield even more magnified compressive stresses at the joints, i.e. additional compressive stresses, provide an even more reliable/strong sealing of the cylinder body at the joint(s).

According to an embodiment of the present invention, the pre-stressing means comprises at least one pre-stressed surface for each joint, and the pre-stressed surfaces are arranged on an inner wall of the cylinder body. Hence, the mentioned advantages of the pre-stressed surfaces are provided to the inner wall of the cylinder body for sealing the adjacent edges.

According to an embodiment of the present invention, the pressure vessel is arranged to be operable in a pressure range comprised between 20 MPa-700 MPa, preferably between 80 MPa-220 MPa.

### DETAILED DESCRIPTION OF THE PREFERRED EMBODIMENTS

The invention is mainly described with reference to a few embodiments. However, as is readily appreciated by a person skilled in the art, other embodiments than the ones disclosed are equally possible within the scope of the invention, as defined by the appended claims.

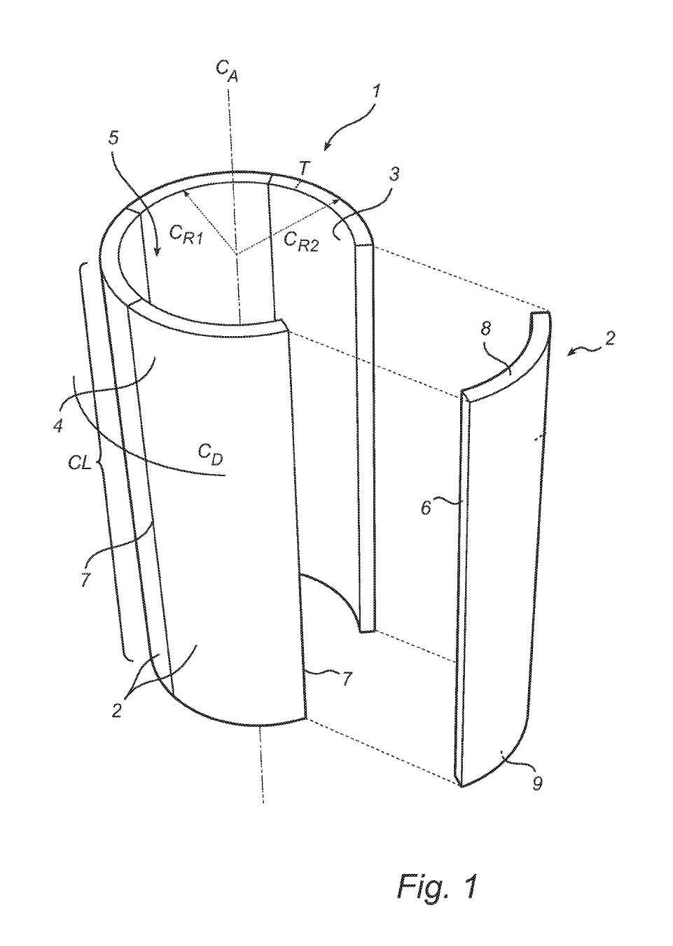

With reference to FIG. 1, there is schematically shown an illustration of a cylinder body 1 according to an embodiment of the present invention. The cylinder body 1 comprises five cylinder segments 2, wherein each cylinder segment 2 is shaped as an essentially rectangular slab. The lengths of the cylinder segments 2 extend in parallel with the cylinder axis C_{A}, wherein the lengths of the cylinder segments 2 define C_{L}, being the length of the cylinder body 1. The widths of the cylinder segments 2 are slightly arched in a circumferential direction C_{D} such that the cylinder segments 2 are arranged for connecting each other in the circumferential direction C_{D}, thereby forming the cylinder body 1.

Although the depicted cylinder body 1 in FIG. 1 comprises five cylinder segments 2 arranged to form the cylinder body 1, it is of course conceivable to construct a cylinder body 1 of, practically, any number of cylinder segments 2. Preferably, the cylinder segments 2 are formed in accordance with the description herein, which entails that the cylinder segments 2 may be assembled in accordance with the description in the co-pending applications “Residual stress reduction in welding”, “Welded sealing of pressure cylinder vessel” and/or “Pressure vessel and high-pressure press” to form the cylinder body 1. Further advantages and design and construction details of the cylinder segments are described thoroughly in the said co-pending applications by the same applicant, which hereby is incorporated herein by reference.

The cylinder body 1 has an inner cylinder radius C_{R1} from the cylinder axis C_{A}, through the centre of the cylinder 1, to an inner surface 3 of the cylinder body 1, and a outer radius C_{R2} from the cylinder axis C_{A} to an outer surface 4 of the cylinder segments 2. The thickness T of the cylinder segments 2 is hence T=C_{R2}−C_{R1}. When the cylinder body 1 is assembled, the inner surfaces 3 of the cylinder segments 2 define a pressure chamber 5. Further, the cylinder body 1 may be closed at the ends by lids (not shown) which are held in place by a framework (not shown).

At adjacent longitudinal edges 6 of the cylinder segments 2, joints 7 are formed between the cylinder segments 2, wherein each joint 7 extends essentially in parallel with the cylinder axis C_{A}, and extends the entire cylinder body length C_{L}. At the top and bottom of the segments 2, the segments 2 form a top edge 8 and a bottom edge 9, respectively, wherein these are flat. The top edge 8 and the bottom edge 9 each forms a common plane, i.e. the segments 2 are leveled.

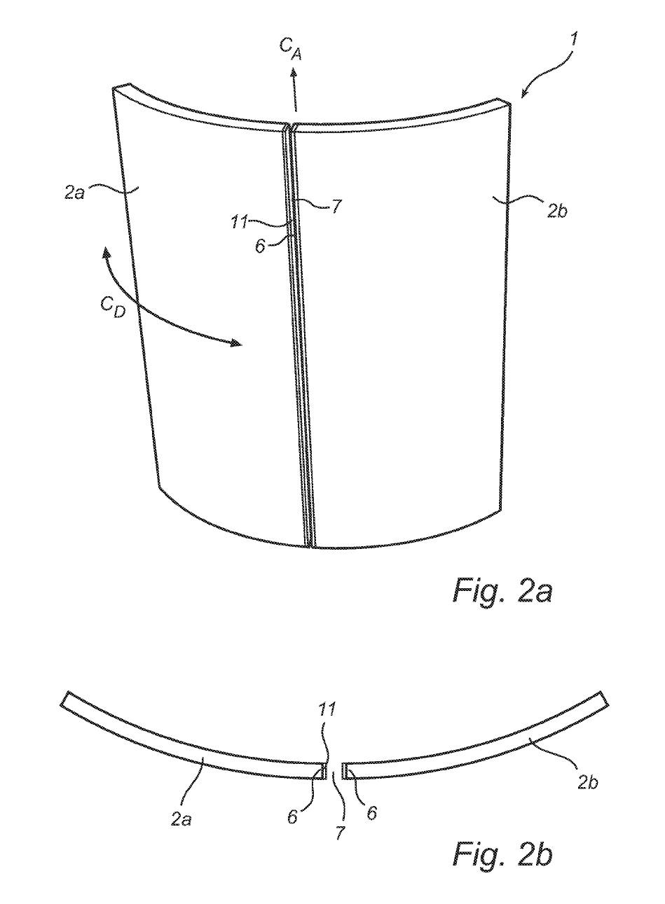

In FIG. 2a, there is schematically shown a part of the assembly of the cylinder body 1 between two cylinder segments 2a, 2b. The joint 7 comprises an intermediate layer 11 which extends along the joint 7 at adjacent longitudinal edges 6 of the cylinder segments 2a, 2b. Here, the intermediate layer 11 is provided as a coating/covering/plating on both adjacent edges 6, i.e. the joint comprises two intermediate layers 11. However, it will be appreciated that the joint 7 may, as an alternative, comprise one intermediate layer 11 provided on one of the edges 6. Alternatively, the joint 7 may partly comprise an intermediate layer 11, i.e. that an intermediate layer 11 is provided partly on one or both edges 6.

FIG. 2b schematically shows an above view of the part of the cylinder body 1 in FIG. 2a for an increased understanding of the figure. It will be appreciated that the cylinder segments 2a, 2b are separated at the joint 7 in FIGS. 2a and 2b for illustrative purposes only, i.e. for an increased understanding of the figures.

In FIG. 2c, there is schematically shown a part of the assembly of the cylinder body 1 between two cylinder segments 2a, 2b, similar to FIG. 2a. However, in this embodiment, the joint 7 comprises an intermediate layer 11 which extends along the joint 7 between adjacent longitudinal edges 6 of the cylinder segments 2a, 2b. In other words, the intermediate layer 11 is provided as a foil/sheet/plate which may be inserted between the adjacent edges 6 before pre-stressing the cylinder body 1. It will be appreciated that the joint 7 may, as an alternative, comprise an intermediate layer 11 that only partly extends along the joint 7, i.e. that the intermediate layer 11 may be provided only at portions between the adjacent edges 6.

FIG. 2d schematically shows an above view of the part of the cylinder body 1 in FIG. 2c for an increased understanding of the figure. It will be appreciated that the cylinder segments 2a, 2b are separated at the joint 7 in the figures for illustrative purposes only, i.e. for an increased understanding of the figures.

Furthermore, it will be appreciated that the dimensions of the cylinder segments 2a, 2b and the intermediate layers 11 may vary, and that the FIGS. 2a-2d used are for demonstration purposes only. For example, the thickness of the intermediate layers 11 may be much smaller than that depicted, in relation to the thickness of the cylinder segments 2a, 2b.

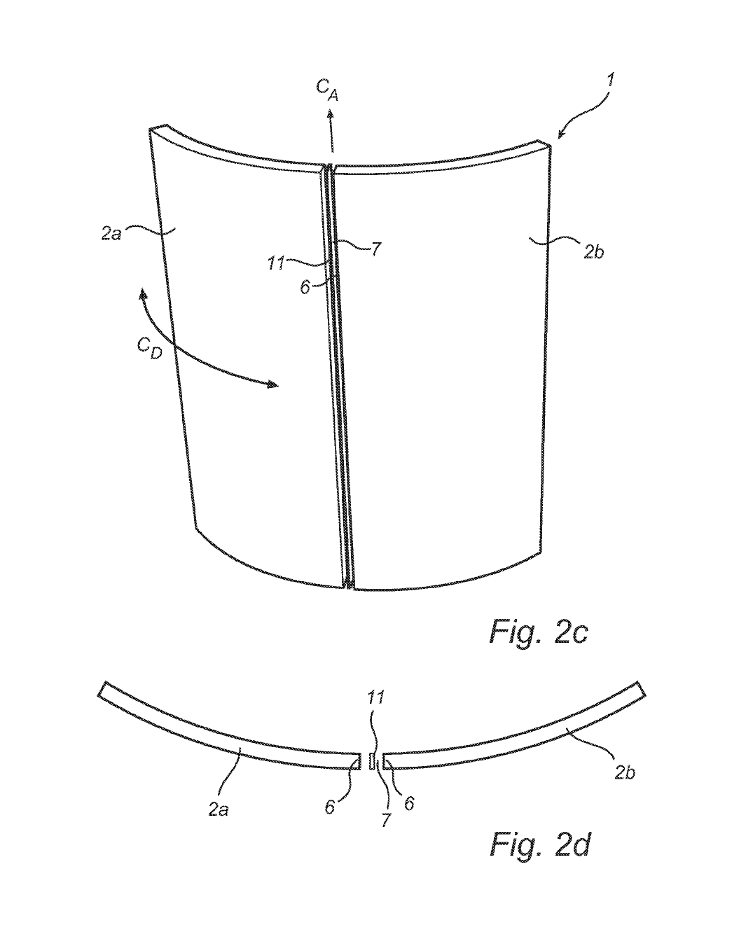

With reference to FIG. 3, there is schematically shown an illustration of a part of a cylinder body 1. The figure shows the two cylinder segments 2a, 2b, as previously shown in FIG. 2, wherein the joint 7 comprises intermediate layers 11 provided along the joint 7 at the adjacent edges 6 of the cylinder segments 2a, 2b. The joint 7 thereby provides a sealing for the adjacent edges 6, i.e. a sealing where the cylinder segments 2a, 2b are connected and in contact with each other.

The outer surface of the cylinder body 4 is provided with a first pre-stressing means in the form of a package of wound steel bands 20. The bands 20 are tightly wound around the envelope surface in the circumferential direction C_{D} of the cylinder body 1 for exerting radial compressive forces in a radial direction C_{R} on the cylinder segments for attaining tangential compressive stress at the joint 7. When the cylinder body 1, which comprises a plurality of cylinder segments 2 arranged longitudinally, is pre-stressed with the bands 20 arranged circumferentially around the cylinder body 1, the construction may resemble that of a beer barrel.

The pre-stress from the bands 20 presses the cylinder segments 2a, 2b against each other in the circumferential/tangential direction C_{D}, at the adjacent longitudinal edges 6. It will be appreciated that although the adjacent edges 6 in FIG. 3 are depicted with a separation at the joint 7, this separation is only provided for an easier understanding of the figure. Hence, after being exerted to the pre-stress of the bands 20, the adjacent edges 6 will be pressed together.

The pre-stress from the bands 20 yields a compressive stress 16 in the intermediate layer(s) 11 in the circumferential direction C_{D} of the cylinder body 1. As a response to this compressive stress 16, the intermediate layer(s) 11 wants to expand in the circumferential direction C_{D}, and also in the axial direction C_{A}. The high-pressure press counteracts any expansion of the intermediate layer 11 in the axial direction C_{A} by the second pre-stressing means (not shown). Hence, the first pre-stressing means 20 provides compressive stresses 16 in the intermediate layer 11 in the circumferential direction C_{D}, and the stress applied from the second pre-stressing means in the axial direction C_{A} provides compressive stresses 15 in the intermediate layer 11 in the axial direction C_{A}. Hence, the first pre-stressing means 20 and/or the second pre-stressing means provide a stress at the joint 7, wherein the joint 7 provides a fluid-tight seal at the adjacent edges 6 such that pressure medium does not leak between the adjacent edges 6 during operation of the pressure vessel.

The joint may comprise (very) smooth edges 6, i.e. the edges 6 of the cylinder segments 2a, 2b may be treated such that the cylinder segments 2a, 2b interconnect evenly and with a large contact surface at the joint 7. By this, the joint 7 may be sufficient for sealing the adjacent edges 6 after pre-stressing the cylinder body 1. Alternatively, as shown in FIGS. 2-3, the joint 7 may comprise at least one intermediate layer 11 for smoothening out unevenesses/roughnesses at the edges 6, for improving the sealing.

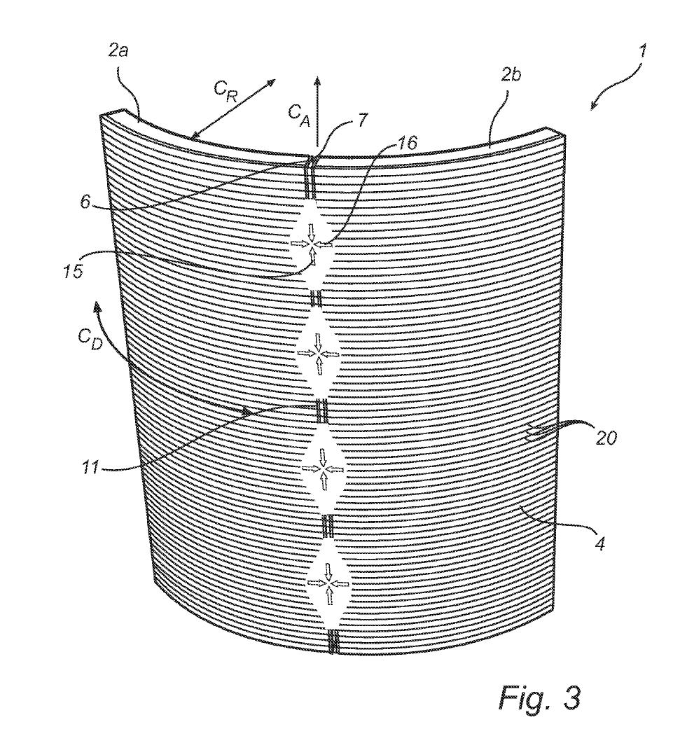

In FIG. 4, a portion of the cylinder body 1 is shown along a direction of the cylinder axis C_{A}, wherein a first cylinder segment 21 and a second cylinder segment 22 are arranged for a longitudinal connection. At adjacent longitudinal edges 23, 24 of the cylinder segments 21, 22, respectively, a joint 25 is formed for sealing the adjacent edges 23, 24. The joint 25 comprises an intermediate layer 30 which is coated/covered/plated on the cylinder segment 22. Alternatively, the intermediate layer 30 may be provided e.g. along the cylinder segment 21. The intermediate layer 30 extends along an axial (longitudinal) direction, i.e. in a direction of the cylinder axis C_{A}. Furthermore, the intermediate layer 30 extends in a radial direction C_{R} as a depth D which may approximately be the thickness of the cylinder segments 21, 22. The thickness W of the intermediate layer 30 may be comprised between 0.01-5 mm, preferably between 0.05-0.2 mm. It will be appreciated that the gap between the cylinder segments 21, 22 at the joint 25 is for illustrative purposes only, i.e. for an increased understanding of the figure, and that dimensions may vary.

It will be appreciated that the intermediate layer 30 may alternatively be provided on only a portion of the cylinder segment 24. For example, a small piece of intermediate layer 30 may be provided at the leftmost edge (facing the outside) of the joint 25, whereas another piece of intermediate layer 30 may be provided at the rightmost edge (facing the inside) of the joint 25.

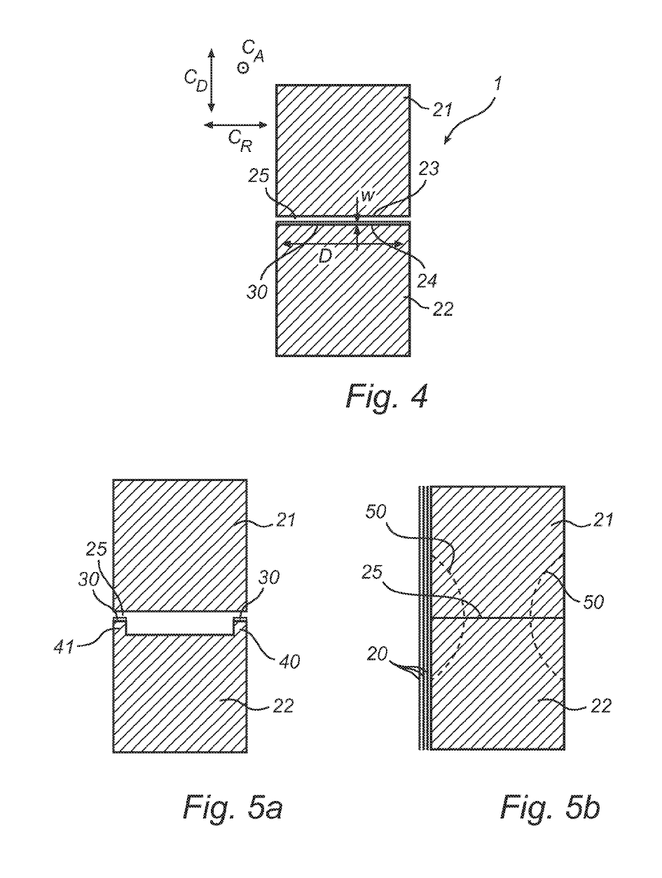

FIG. 5a shows a portion of the cylinder body 1 along a direction of the cylinder axis C_{A}, wherein a first cylinder segment 21 and a second cylinder segment 22 are arranged for a longitudinal connection, analogously to FIG. 4. In this embodiment however, a pair of pre-stressed surfaces 40, 41 protrude in the circumferential direction C_{D} from the cylinder segment 22 in a vicinity of the inner and outer portions of the cylinder segment 21. Hence, the pre-stressed surfaces 40, 41 are provided on one side of the joint 25, towards the cylinder segment 21. The pre-stressed surfaces 40, 41 take up forces exerted thereon from the pre-stressing means, and are arranged for transferring the forces via the cylinder segments 21, 22 to the joint 25 such that an additional compressive stress at the joint 25 is attained. In this way, the profile of the edge of the cylinder segment 22 comprises step-like shapes at the end portions of the joint 30 in a radial direction C_{R}, whereas the cylinder segment 21 is shown with a substantially flat edge. Alternatively, pre-stressed surfaces may also protrude from the cylinder segment 21 at the end portion of the joint 25, towards the outside and the inside of the cylinder body 1. Furthermore, other profiles of the joint 25 may be feasible for attaining additional compressive stress at the joint 25.

On top of the pair of pre-stressed surfaces 40, 41, an intermediate layer 30 may be provided. As the intermediate layer 30 may even out roughnesses at the pre-stressed surfaces 40, 41 and/or at the portions of the cylinder segment 21 the surfaces abut, the sealing properties of the cylinder body after pre-stressing may be even further improved. Alternatively, the pre-stressed surfaces 40, 41 may be provided without any intermediate layer 30. It will be appreciated that the protrusion of the pre-stressed surfaces 40, 41, i.e. the height of the surfaces 40, 41 in FIG. 5a, is exaggerated, due to reasons of an increased understanding.

FIG. 5b shows a portion of the cylinder body 1 along a direction of the cylinder axis C_{A} analogously to FIG. 5a, wherein first pre-stressing means 20 are arranged in the longitudinal direction C_{D} for attaining tangential compressive stress at the joint 25. Here, the cylinder segments 21, 22 are pre-stressed such that the pre-stressed surfaces 40, 41 have decreased, and eventually, vanished, as the material has yielded to the forces from the pre-stressing means 20. The joint 25 is, for simplicity, shown as an even junction or interface between the cylinder segments 21, 22. The joint 25 may comprise an intermediate material, applied to the pre-stressed surfaces 40, 41 of FIG. 5a, for evening out any roughnesses of the cylinder segments 21, 22. The perforated line 50 indicates/defines an area in a vicinity of the pre-stressed surfaces which have yielded to the pre-stressing forces. Hence, in these areas of the joint 25, at the inner and outer portions of the cylinder segments 21, 22, the material of the cylinder segments 21, 22 is exerted to the compressive stress from the (previously present) pre-stressed surfaces. The compressive stress at the joint 25 in the areas as defined by lines 50 may further improve the sealing properties of the cylinder body.

Although an exemplary embodiment of the present invention has been shown and described, it will be apparent to those having ordinary skill in the art that a number of changes, modifications, or alterations to the invention as described herein may be made. Thus, it is understood that the above description of the invention and the accompanying drawing is to be regarded as a non-limiting example thereof and that the scope of the protection is defined by the appended claims.

1. A pressure vessel comprising a pressure chamber (5) arranged for accommodating a pressure medium, comprising
at least one cylinder segment (2) arranged for longitudinal connection to form a cylinder body (1), whereby a joint (7) is formed at adjacent edges (6) of the at least one cylinder segment for sealing the adjacent edges, and
first pre-stressing means (20) arranged for exerting radial compressive forces on the at least one cylinder segment for attaining tangential compressive stress (16) at the joint(s).

2. The pressure vessel as claims in claim 1, further comprising
second pre-stressing means arranged for exerting axial compressive forces on the at last one cylinder segment for attaining axial compressive stress (15) at the joint(s).

3. The pressure vessel as claimed in claim 1, further comprising at least one cylinder segment arranged for axial connection to form a cylinder body, whereby a joint is formed at adjacent edges of the at least one cylinder segment for sealing the adjacent edges.

4. The pressure vessel as claimed in claim 1, wherein the joint comprises at least one intermediate layer (11) provided along at least a portion of each joint.

5. The pressure vessel as claimed in claim 4, wherein the at least one intermediate layer is a coating, a covering, a plating, or the like.

6. The pressure vessel as claimed in claim 4, wherein the at least one intermediate layer is a foil, a sheet, a plate, or the like.

7. The pressure vessel as claimed in 4, wherein the at least one intermediate layer has a hardness which is below the hardness of the at least one cylinder segment.

8. The pressure vessel as claimed in claim 4, wherein the at least one intermediate layer has a bulk modulus below 250 Gpa, preferably below 200 Gpa.

9. The pressure vessel as claimed in claim 4, wherein the at least one intermediate layer comprises at least one metal selected from Fe, Cu, Sn, Pb, Ag and Au.

10. The pressure vessel as claims in claim 4, wherein the at least one intermediate layer comprises at least one material selected from rubber, silicone, plastic and glue.

11. The pressure vessel as claimed claim 4, wherein the thickness (W) of the at least one intermediate layer is comprised between 0.01-5 mm, preferably between 0.05-0.2 mm.

12. The pressure vessel as claimed in claim 4, wherein the at least one intermediate layer is provided along at least a portion of the joint on an inner wall of the cylinder body.

13. The pressure vessel as claimed in claim 1, further comprising at least one pre-stressed surface (40, 41) provided on at least one side of the joint for taking up forces exerted thereon from the pre-stressing means, and wherein the at least one pre-stressed surface is arranged for transferring the forces via the at least one cylinder segment to the joint such that an additional compressive stress at the joint is attained.

14. The pressure vessel as claims in claim 1, wherein the pressure vessel is arranged to be operable in a pressure range comprised between 20 Mpa-700 Mpa, preferably between 80 Mpa-220 Mpa.

15. A high-pressure press for isostatic pressure treatment of articles, comprising a pressure vessel as defined in any one of the preceding claims, including a force-absorbing press frame provided around the force absorbing pressure body.
